(19) United States
(12) Patent Application Publication
(10) Pub. No.: US 2020/0074811 A1
(43) Pub. Date: Mar. 5, 2020

(54) METHODS FOR CONDUCTING PLAY OF A WAGERING GAME

(71) Applicant: Bally Gaming, Inc., Las Vegas, NV (US)

(72) Inventor: Roger M. Snow, Las Vegas, NV (US)

(21) Appl. No.: 16/559,407

(22) Filed: Sep. 3, 2019

Related U.S. Application Data
(63) Continuation of application No. 13/549,969, filed on Jul. 16, 2012, now abandoned.
Application No. 13/549,969 is a continuation of application No. 11/156,352, filed on Jun. 17, 2005, now abandoned.

(51) Int. Cl. G07F 17/32; A63F 3/00; A63F 1/06

(52) U.S. Cl. CPC G07F 17/3293; A63F 3/00157; A63F 1/067; A63F 2001/005; G07F 17/326; G07F 17/3225; G07F 17/3223

(57) ABSTRACT

A variant game of Hold 'Em poker allows for rules of play of one or all of players being allowed to remain in game with an option of checking or making specific wagering amounts in first play wagers, being limited in the size of subsequent available play wagers or prohibited from making additional play wagers if a first play wager has been made, being limited in the size of available later play wagers if a first or earlier play wager has been made, and having the opportunity for at least two and as many as three or four distinct opportunities in the stages in the play of a hand to be able to make one or more play wagers.

### CROSS-REFERENCE TO RELATED APPLICATIONS

This application is a continuation of U.S. patent application Ser. No. 13/549,969, filed Jul. 16, 2012, pending, which is a continuation of U.S. patent application Ser. No. 11/156,352, filed Jun. 17, 2005, now abandoned. This application is also related to U.S. patent application Ser. No. 13/455,742, filed Apr. 25, 2012, pending, which application is a divisional of the aforementioned U.S. patent application Ser. No. 11/156,352. This application is also related to U.S. patent application Ser. No. 12/490,233, filed Jun. 23, 2009, pending. The disclosure of each of the foregoing applications is hereby incorporated herein by this reference in its entirety. This application is also related to U.S. patent application Ser. No. 13/631,816, filed Sep. 28, 2012, pending, which is a continuation-in-part of this application.

### FIELD

The present invention relates to wagering games, casino table wagering games, casino table playing card wagering games, and variants of casino table wagering games that use poker ranks in determining outcomes.

### BACKGROUND

Many different wagering games presently exist for use in both home and casino environments. Such games should necessarily be exciting, uncomplicated and easy to learn so as to avoid frustrating the players. Poker games in particular have gained widespread popularity because of their established ranking of hands and well-known rules. Furthermore, the games usually involve numerous wagering opportunities for the players, thus increasing player participation and excitement. Lastly, the games move fairly quickly to maintain player interest. All of these factors have created games that are widely accepted and widely known.

Variations in wagering structures can also increase the excitement and acceptance of such wagering games. U.S. Pat. No. 5,417,430 to Breeding discloses a poker game with an altered wagering scheme, thus allowing the player the opportunity to compete for additional and larger prizes or payouts.

Other variations can be made to standard games to allow more player opportunity and involvement. U.S. Pat. No. 5,098,107 to Boylan et al. discloses a game wherein additional game symbols are added to increase wagering opportunities. This allows the player the opportunity to place several wagers on different portions of the game while the game is being played.

Many variations in the play of poker-type games have been introduced to increase the excitement and interest in the play of both table and video versions of poker.

Many of the poker variants mentioned above are played against a dealer hand. In more traditional forms of poker, players play against other players, and a highest ranking hand wins the round. For example, Texas Hold 'Em is a game in which players compete against other players to make a best five-card hand from seven available cards. After the first round of wagering, each player is dealt two hole cards. Five community cards are dealt face down on the table. After viewing the hole cards, each player is given the opportunity to make an additional wager. The additional wager must at least match the opening bet for the round or the player folds. The dealer then reveals the first three community cards. Another round of betting takes place. Then the dealer reveals the fourth community card and the last round of betting takes place. The dealer reveals the seventh card and compares each player's best five-card hand to determine which player gets the high hand. The high hand wins the pot. In some forms of the game, the pot is split so that the second best hand wins a bad beat award of 20% of the pot, for example, and the player with the highest hand wins 80% of the pot.

A variation of Texas Hold 'Em is Omaha or Omaha Poker in which the betting is identical, but the players initially receive four hole cards, of which a maximum of two hole cards may be used in determining the final rank of a five-card poker hand. The game is often played as a Hi-Lo game, in which the final pot may be split between the highest hand and the lowest hand, according to poker ranks. A single player may win both Hi hand and Lo hand by declaring and winning both ranking competitions.

U.S. Pat. No. 6,102,402 to Scott describes a community card-based poker game referred to as a “bad beat stud” game. Each player makes an initial ante wager and then each player and the dealer receive five cards each, face down. The player makes a “first” wager to see a sixth card and a “second” wager to see a seventh card. The sixth and seventh cards are each community cards used by each player and the dealer. Each player's hand is analyzed to see if the player has a qualifying hand of at least a pair of deuces or better. If the player does not qualify, all wagers are lost by the player. If the player's hand does qualify, all cards of the dealer's hand are turned face up and each player's hand is compared to the dealer's hand using conventional five-card poker hand rankings to determine whether the player's hand has a higher ranking poker hand than the dealer's hand. Each player also optionally may make a side bet wager to be eligible for special payouts, including a “bad beat” payout. The special payout can take either of two forms: 1) the player wins preselected payout amounts for poker hand rankings of at least a four-of-a-kind if the player's hand beats or ties the dealer's hand, or 2) the player wins other preselected and much higher amounts for poker hand rankings of at least a straight or higher that the player achieves but the player's hand loses to the dealer's hand. Alternatively, the dealer's hand is analyzed to determine whether the dealer has a qualifying hand.

U.S. Pat. No. 6,467,771 to deKeller describes a method for playing a casino game wherein, in a table game format, players make a pot wager and a separate outcome wager. Each player is dealt a plurality of cards, some face up and some face down, and some community cards are additionally dealt. Players are given the option of increasing their outcome wagers and raising the pot during play. The pot won by the player with the highest ranking hand and outcome wager(s) are won based upon a schedule of winning outcomes. For an electronic version, the method includes the player making wagers as indicia are revealed and given the opportunity of holding or discarding indicia during play. In certain embodiments, the casino wins at least a portion of the pot based upon either certain community or non-dealt card combinations.

U.S. Pat. Nos. 6,206,373 and 6,637,747 to Garrod describes methods of and apparatus for playing a card game. In one method, the dealer's hand contains a specified card, such as, e.g., the ace of spades, displayed face up. From the remainder of the deck, each player is dealt two facedown cards. After each player views the two facedown cards, each player may act upon his or her hand. The player may be given the option to fold and receive a portion of the original wager back. Alternatively, the player may remain in the game, leaving the original wager unchanged. As a further alternative, the player may be given the option to increase the wager up to a determined amount. After making a decision, the five common cards are dealt face up. The common cards are common to each of the players' hands and to the dealer's hand. The dealer is then dealt one card face up to complete the deal. Each player compares his or her best five-card hand to the dealer's best five-card hand to determine if that player is a winner. Additionally, the player may receive a bonus for certain hands. Further, the player may fold and receive a return based on all or some portion of the wager for having one or two of a predetermined card (such as a deuce) in the player's initial two cards.

U.S. Pat. No. 6,517,072 to McInerney describes a playing card wagering game method where each player antes one unit. The dealer will deal four cards face down to each player and four cards face down to himself. Each player evaluates their hand and elects to either fold or challenge the remaining players and dealer. Any player who folds surrenders his ante to the house. The total amount of ante bets remaining after each player evaluates his hand will be referred to as the “ante pot.” All players electing to remain in the game, or challenge (including the dealer), must wager an amount equal to the ante pot. The dealer always challenges the pot. After each player has elected to either fold or challenge, the dealer, after “burning” a card, will deal or “flop” another three community cards to be used by all challenging participants. The highest poker hand of each participant using their initial four cards plus the three community cards wins the pot. The first player to act is determined on a rotating basis to eliminate position advantage. Single player versus the dealer has the option to double the “ante pot,” resulting in the dealer likewise adding to the ante pot.

U.S. Pat. No. 6,581,936 to Zoccolillo describes a casino card gaming method utilizing a conventional 52-card deck and begins by first determining the players for a given round. Players may elect to be eligible for receiving a bonus card. The individual players' hands, a set of common cards and a bonus card for players eligible for the bonus card are dealt. Players that continue through the round determine whether to play the hand as dealt or to utilize the common cards. Players utilizing the common cards discard a number of cards from their hands equal to the number of common cards. The relative ranking of the final hands for the players is determined with the relative ranking based upon the statistical likelihood of obtaining predetermined combinations of cards.

U.S. Pat. No. 6,827,348 to Mitchell describes a playing card wagering game method that involves each player wagering an initial blind bet against the dealer and an optional premium odds side bet for premium-dealt hands having a rank equal to a pair of aces or higher within the first five cards players are dealt, resulting in a payout of six to one. Each player and the dealer are dealt five cards in succession face down. Two common cards are dealt face down in succession. Dealer turns the dealer's dealt hand face up to reveal the rank and suit of cards. Players elect to hold on to their dealt hands for higher odds payout of two to one or place a draw bet equal to their initial bet to include the use of the two common cards in play to improve their hands, resulting in payouts of even odds for using the first common card and one half odds, one for two, for using the second common card. The dealer then turns the first and second common cards face up. The dealer always uses the combination of the dealer's dealt hand and both common cards to make the highest ranked poker hand possible. The dealer turns the players' cards face up and declares rank of all hands and resolves all wagers.

There have recently been casino table wagering games introduced with more flexible wagering structures. As opposed to the more rigid wagering structures of games such as CARIBBEAN STUD® poker (see U.S. Pat. No. 4,836,553) where there is an ante wager and a play wager that must be exactly twice the ante wager, games such FOUR CARD POKER™ games, CRAZY FOUR POKER™ games (as disclosed in U.S. patent application Ser. No. 10/152,325 filed May 20, 2002, and U.S. patent application Ser. No. 10/864,051, filed Jun. 8, 2004, now U.S. Pat. No. 7,387,300) allow the player to choose among different amounts of play wagers (as compared to the initial ante wager).

One new format of a hold 'em poker-type game provides more cards to the dealer than to the players as described in U.S. patent application Ser. No. 10/658,865, filed Sep. 9, 1993 and published Mar. 10, 2005, now U.S. Pat. No. 7,140,614.

### BRIEF SUMMARY

A new variant game of Hold 'Em poker allows for rules of play of one or all of players being allowed to remain in the game with an option of checking or making specific wagering amounts in first play wagers. For purposes of this disclosure, “checking” means staying in the game without making an additional wager. Games of the present invention have limits and prohibitions regarding the size of the bets that can be made as the game progresses. Play wagers if made earlier in the game can be multiples of later-made play wagers. For example, players may be given the opportunity for making play wagers during at least two different stages of play and may have the opportunity to make a play wager in as many as three or four distinct stages in the play of a single hand. As the game progresses, more information is available to the player and consequently the permitted amounts bet decrease with increasing information.

Games of the present invention can offer side bets that are based on an entire Hold 'Em hand because players may only check or make play wagers, but do not fold. Since there is no folding of hands, an entire hand can be considered in resolving side bets.

The game is based upon standard play of best five-card Hold 'Em poker games, although fewer total cards (e.g., 1, 2, 3 or 4 cards) or more cards (such as 6, 7 or 8 cards) may be used as compared to the standard number of cards (5 cards) used in regular play of Hold 'Em games. Any number of community cards can also be used, but providing more than one community card provides additional betting opportunities. Although a preferred form of the game is based on five-card poker hand rankings, other poker hand ranking systems can be used, such as known three-card poker rankings, four-card poker rankings and seven-card poker rankings, to name a few.

### BRIEF DESCRIPTION OF THE FIGURES

FIG. 1 shows a perspective view of a prior art format for an automated gaming system.

FIG. 2 shows an overhead view of a prior art format for an automated gaming system.

FIG. 3 shows a side view of a prior art format for an automated gaming system.

FIG. 4 shows a block schematic of the electronic configuration of a prior art animated gaming system.

FIG. 5 shows a perspective view of a format for an automated gaming system according to the present invention.

FIG. 6 shows a schematic of a gaming engine useful in the practice of the present invention.

FIG. 7 shows a schematic of a player station useful in the practice of the present invention.

FIG. 8 shows a schematic of a preferred embodiment of a game display useful in the practice of the present invention.

FIG. 9 shows three typical wagering layouts for a casino card table Hold 'Em game according to the teachings of the invention.

FIG. 10 shows a flow diagram for a process according to one embodiment of the present invention.

### DETAILED DESCRIPTION

The gaming methods described in this disclosure may be played in a number of different formats such as live action casino table gaming format with a live dealer and real playing cards and chips, or with various automated formats with partial (e.g., wagers only) or complete (wagers, cards, dealer, etc.) automation of the format. Such formats include traditional video gaming apparatus and modern multi-player platforms such as those described in co-pending U.S. patent application Ser. Nos. 10/764,995, 10/764,994 (now U.S. Pat. No. 7,661,676), and Ser. No. 10/764,827, each filed on Jan. 26, 2004, the apparatus of each of which is described in more detail in the disclosure below.

A basic format (whether on a table or automated device, with computer, processor, monitor, cash/credit/token receptors, etc.) of play involves a player making at least a first ante wager to enter the game against a dealer's hand. The dealer and players each receive at least one card. In one example of the game, the dealer provides two cards to each player having made an ante wager (the player cards may be face up or face down, although providing the player cards face down has some intrinsic desirable features for the house, and players tend to prefer their cards to be hidden, even though that can be disadvantageous to the players) and two cards to the dealer. Although it is preferred that the dealer and players each receive the same number of cards, the invention contemplates dealing unequal numbers of cards to the dealer and players, which will alter the house advantage. For example, giving the dealer three cards instead of two cards and allowing the dealer to discard one card would provide a greater advantage to the house.

One example of the game play described herein shall be referred to under the game nomenclature of “ULTIMATE TEXAS HOLD 'EM”™ and can be described as follows. Players make at least one ante wager or preferably at least two initial equal wagers, an ante wager and a blind wager. The ante wager is mandatory to participate in the game. In a preferred form of the game, the blind wager is also mandatory. A bonus wager is optional (called the “trips” wager) and is based on the player's resulting five-card hand having an ultimate hand rank of at least three-of-a-kind, from a best five-card hand. Other higher-ranking hands also pay bonus payouts according to a pay table listing winning hand outcomes and corresponding payout odds. The minimum hand of three-of-a-kind is selected based on the mathematics of the game and is a matter of design choice. According to an example of the game, the dealer deals each player two hole cards face down. The dealer receives a two-card dealer hand of two hole cards (face down). This two-card hand may be dealt at the same approximate time as the player hand or nearer the end of the game, as when all wagers have been placed and the player has seen all available cards.

In one aspect of this example, after viewing the hole cards, players may have only one opportunity to make a play bet, even though that play bet may be made at different predetermined stages in the progression of the hand. Furthermore, an amount of that play bet may vary with the stage of progression of the hand of the game. In one example, the player can make the play bet only once, and can make the wager at up to four different stages in the progress of the game. With each passing step, the amount of the permitted wager decreases. The player is, therefore, rewarded for risking larger amounts earlier in the game, when less information about the outcome of the hand is available for the player. It is important to the invention that with each successive stage of the game, more information becomes available to the player regarding the quality of the player's hand, and lesser amounts are permitted to be wagered.

It is desirable to set limits on the amount of each possible play bet wager. For example, in the early stages of a round, the play bet can vary between 1× and 10×, 1× to 6× or 1×to 4× the ante, for example. At the latest stage, the play bet may be limited to no more than 1× the ante. Depending upon the stage of the game when the play bet is made, with earlier bets allowing larger play bets, and later bets allowing for relatively smaller play bets, higher payouts can be made to a player who puts more at risk when less information is available.

After seeing their two hole cards, players have a specific choice-check (remaining in the game) or making a specific play wager amount (e.g., precisely a 4× wager) or a range of wagers (e.g., between 1× and 10×, between 2× and 5×, between 2× and 4×, 3× or 4×, etc). The “X” indicates a multiple of the ante wager. In one embodiment, players may not fold. This is a reasonable requirement as it places the player in no further economic risk, and he is allowed to see additional card(s) that may well improve an apparently weak hand. When no folding is permitted, the range of payouts on the side bets can be increased because it becomes possible to use a complete hand of cards to consider in determining winning outcomes.

The dealer then displays (deals or reveals) the first set of community cards, preferably three community cards. In other forms of the invention, more or less than five cards are dealt as community cards and the initial display of community cards equals 1, 2, 4, 5 or 6 community cards, rather than three.

In one example of the game, before any community cards are revealed, the players know only two out of seven cards. After the initial set of community cards are revealed, players know the identity of five out of seven. When the fourth community card is dealt, they know six out of seven cards and when the last community card is turned over, they know all seven and can pick the best five cards. The first three cards in Hold 'Em games is typically referred to as the “flop.” The fourth card is referred to as the “fourth turn card,” and the fifth community card is referred to as the “river card.”

After seeing the flop (the first set of community cards, such as the preferred three community cards), the players have the following options. If they have not already made the first wager (e.g., the preferred specific amount wager such as the 4× play bet), they may again check (remaining in the game without wagering at this time) or make an alternative second play wager of an amount less than the amount of the first play wager, such as a 2× or 3× the ante wager for the second play wager. If the player made the original first play wager, e.g., the 4× play wager, the player may not make an additional play wager and must check for the remainder of the game. According to this example of the game, players cannot fold. It is contemplated that additional play wagers may be made in smaller amounts, but this is a less preferred embodiment of play. It is preferred that no action, other than a check, can be made by the player who made the 4× wager at this point, although in other examples of the game, folding can also be allowed.

Players may also have a choice to play a range of play wagers, such as from 1× to 4× the ante in the original play wager, and 1× to 3× the ante in the second play wager, etc.

The dealer then displays additional community cards, preferably up to the total number of community cards, such as both of the remaining community cards (fourth turn and the river), effectively at the same time since there need not be any further wagering allowed. Another embodiment would allow an additional wager with the fourth but not the fifth common card revealed where the player has not previously made a play wager. An example of such a wager could be 2× or 3× the ante or a range of 1× to up to 3× the ante. In one preferred form of the invention, play wagers are allowed after the first two player hands are revealed, after the flop is revealed, after the fourth card is revealed and after the fifth community card is revealed, for a total of four play bet opportunities.

Players now know all seven of the cards from which they may make their best five-card hand. If the player has made no play wagers in the previous steps, they may make a 1× play wager or fold. If the player has made a previous play wager, the player may check. In a less preferred embodiment, the player may also fold.

The dealer then reveals his two hole cards and compares his best hand (best five of seven cards poker hand using his two hole cards and the five community cards to form the five-card hand). In one example of the invention, players are free to use any five of the seven available cards. Players may alternately be required to use their hole cards, or the three highest ranking community cards, or four community cards and one player hole card. Many other minor rule variations may be implemented without departing from the scope of the invention.

The dealer's best five of seven cards hand is compared against each player's best five of seven cards hand to determine head-to-head winners. In one form of the invention, no dealer or player qualifying step is necessary to play the game. In another form of the invention, the dealer and/or players must qualify with a predetermined minimum card ranking in order to play. If the dealer, for example, does not qualify with any pair or better, for example, the ante wagers are returned to the players. However, the play wagers, blind bets and any side wagers are resolved in the normal manner. Play bets are resolved in the normal manner. All winning payouts on side bets are still paid, regardless of whether the dealer qualifies. All automatic bonus payouts are also made. When there is no dealer or player qualification step, then the dealer hand is compared to player hands and the highest ranking hand wins the round. Ante bets are paid even money. Blind bets are paid odds for certain high-ranking hands, and side bets are paid odds according to a pay table.

Players also win 1:1 on play bets when their hand beats the dealer's hand and ties are pushes. The player loses the ante bet and all play bets when the player's hand has a lower rank than the dealer's hand.

The mandatory blind bet is typically equal to the ante but in other forms of the invention can be multiples of the ante. The blind bet wins when the player has a predetermined winning hand rank, for example, a flush or higher, and the player's hand beats the dealer's hand. The blind bet loses when the player's hand loses. The blind bet pushes when the player's hand ties the dealer's hand. The blind bet also pushes when the player's hand is less than a flush but beats the dealer's hand.

Distinct pay tables may be provided for the blind and trips wagers, such as:

Blind payouts

| | |
|---|---|
| Royal flush | 200:1 |
| Straight flush | 50:1 |
| Four-of-a-kind | 10:1 |
| Full house | 2:1 |
| Flush | 3:2 |

Trips payouts

| | |
|---|---|
| Royal flush | 50:1 |
| Straight flush | 40:1 |
| Four-of-a-kind | 30:1 |
| Full house | 8:1 |
| Flush | 7:1 |
| Straight | 4:1 |
| Three-of-a-kind | 3:1 |

### Example of Play

The following example of a hand of play of ULTIMATE TEXAS HOLD 'EM™ poker is provided below.

| Dealer Activity | Player 1 Activity | Player 2 Activity |
|---|---|---|
| Awaits wagers | $5 ante, $5 blind | $10 ante, $10 blind, $5 trips |

The dealer's partial hand of two cards is dealt face down to the dealer, and each of Player 1 and Player 2 receives their two partial hands of two cards each. The cards may be face down, face up or partially exposed for the players, but face down is a preferred method of play.

| Dealer Activity | Player 1 Activity | Player 2 Activity |
|---|---|---|
| Cards Hidden | 10 [symbol] Jack [symbol] | King♥ King♦ |

After viewing their initial partial two-card hands, the players may make their decision on the first play wager. Player 1's hole cards are good, but do not warrant a large wager. If given a choice between a check up to the extreme of 4× the ante, Player 1 would elect to check. He chooses to check because he does not have enough information to determine whether his hand is strong enough to win. Player 2's hand is very good, although it still has not reached a bonus level payout (e.g., three-of-a-kind or better, or at least a straight), but the hand probably warrants the maximum first play wager of 4× or an additional $40.00 wagered. In the preferred embodiment, Player 2 may not make any further wagers, and checks until the completion of the round.

After conclusion of this first play wager round of wagering, the flop (three community cards) is shown. Those cards in this Example are:
King [symbol] , Queen♦ and 7 [symbol] .

These cards provide Player 1 with an outside (two-way) straight draw and two running cards for a club flush, with two cards remaining to be drawn. This hand is considered a relatively good hand. Player 1, who has not yet made a play bet, might, therefore, elect to make the maximum second play wager of 2× the ante, or $10.00. As noted earlier, Player 2 has no further wagers available, but would be happy with the flop, providing a rank of three-of-a-kind at this stage.

| Dealer Activity | Player 1 Activity | Player 2 Activity |
|---|---|---|
| Cards Hidden | $10 2X second play | $40, 4X first play |
| | opportunity | opportunity |

At this point, in the preferred method of play, the last two community cards would be revealed. In this example, the community cards are:
7♦ and 4♥

At this point, the rank of Player 1's hand is a pair of sevens, and the rank of Player 2's hand is a full house.

As both players have made play wagers at this time, if the rules limit player activity to a single play wager during the progress of a hand, no further play wagers may be made. If Player 1 had been conservative in the second play wager stage and checked, then Player 1 might be required to make a third play wager of 1× to remain in the game, may be allowed to check, or may be allowed to fold at this stage. Having made the earlier second play wager, then Player 1 would have no choice but to check at this point. If allowed, Player 2 might even make any possible additional wagers, if they were allowed.

At this point, the dealer would reveal the two cards in the dealer's partial hand. Although it is common for the dealer's two-card partial hand to have been dealt at the same time as the players' partial hands and to have been kept face down, as a security measure (preventing any possibility of those dealer cards having been exposed or partially exposed) the dealer's two cards might be dealt at the end of play, at this point in the play of the hand of the game.

The dealer's community cards are 10♥.Jack♦. This dealer's hand is, in combination with the community cards, identical with the rank of Player 1's hand, so the ante wager is a push according to the rules of play. The blind bet loses.

Player 2's hand rank, as a full house, wins 1:1 on the ante wager ($10), wins 1:1 on the 4× first play wager ($40), wins 2:1 ($20) on the blind wager, and wins 8:1 ($40) on the trips wager for a total win of $110.

A betting layout for ULTIMATE TEXAS HOLD 'EM™ poker games is shown in FIG. 9. A dealer's hand 402 of two cards is shown, and players' hands 404 for three players is also shown. Each player's position is provided with four separate betting areas for the ante wager 406, the blind wager 408, the trips wager 410 and the play wager 412. As there may be only a single play wager made during the play of the game, it is possible to provide only the single play wager betting area 412. The presence or absence of a token or coin in that area 412 at any time may indicate the status and opportunity of players to make play wagers and the amount of play wagers at the various stages of the games. For example, when the flop has been exposed, if there is no bet present in area 412, then the lack of a play wager indicates that a) the player can still make a play wager, and b) that the player is known to have specific ranges or amounts of the second play wager available to that player. In contrast, if a bet is present, then the player is known to have no second play wager available at that stage of the game.

Additional betting areas may be used if additional wagers are allowed. For example, the game rules might allow four different opportunities to make a play bet and provide a different betting circle (and betting limits) for each state of the game. For example, if a player has placed the 4× first play wager, the rules of the game may be modified to allow for additional wagers at the same or at lower odds than the earlier play wagers. If the rules of the game allow for multiple play wagers, it would be desirable to provide multiple betting circles on the layout. For example, if Player 2 in the Example had received a flop of a king and a pair, or two additional kings, he might be frustrated that he could not make an additional wager. The rules of the game might allow for one additional play wager at the same 1:1 odds, or allow subsequent wagers to be placed at lower odds, such as 1:2 odds, returning an additional 50% on the second play wager, but not shifting odds too much in favor of the player with a good hand.

Other forms of the invention are also contemplated. For example, a four-card version of the game could be offered in which each player and the dealer receive one card, and the dealer deals three or four community cards. Players can bet up to 3× the ante after viewing the first card, up to 2× the ante after seeing the first two community cards, and up to 1× the ante after seeing all of the cards.

An interesting aspect of the present invention is that in a preferred form of play, players either check or raise during various stages of play of a Hold 'Em style poker game, but the players are not permitted to fold. This rule enables play of a side bet wager based on the composition of the entire final hand of cards. In known Hold 'Em games, players fold before all of the cards are revealed, making it impossible to base side bet results on a five-card hand, for example. Five-card outcomes have a wider variety of probabilities and allow for game designs offering higher payouts for less frequently occurring hands, such as obtaining a five-card royal flush, for example.

Another aspect of the present invention is that players are permitted to place wagers on a hand after all of the cards are revealed. This feature has great appeal to the player as the player is given the impression that all of the information is available to him or her.

The games of the present invention may be implemented as live table games, television or cable game show games, video poker gaming machine platforms, hand-held games for play, multiple player interactive wagering platform games (with kiosk formats, single player screens, community screens, and/or banks of seats for players with a common dealer screen), cell phone games, games downloadable from the internet, parlor games, games executed on personal computers, palm pilots, play stations and the like. Each of the above game applications is contemplated by the present invention.

A gaming system that can be used to practice the method of the present invention comprises a table and a dealer “virtual” video display system positioned for view by players seated at the table. The table may seat at least two players up to the amount of players that can be configured about the table and have a view of the dealer video display system. Typically, each gaming system will have available at least four player positions, with space determinations considered as to whether there would be 4, 5, 6 or 7 player positions. It is possible to have a completely circular dealer display (e.g., holographic display in a cylindrical centerpiece) and have players distributed around the entire periphery, but this is too dissimilar to standard play arrangements and could slow the game down, as play should approximate that of a live game, with players playing in sequence. A surface of the table will include a generally continuous common display surface for showing all player hands, community cards, dealer hands and any other cards or game pieces used to play the game for any purpose, and, where there are touch screen player controls, for displaying the player touch screen controls. A majority of the table surface comprises a video monitor in one example of the invention. Where there are no touch screen controls, the table surface may include player control panels at each player station near the continuous display surface. The use of a continuous display surface offers some significant advantages in simulating or recreating a standard card table surface. Cards may be readily viewed by other players at a table, which is standard in table games and adds to player enjoyment. Individual monitors, especially where slanted toward the individual players, make such table-wide card reading difficult. The use of the full screen (continuous) display also allows for better animation to be provided, such as displaying virtual images of cards moving to the player and “virtual” chips being placed on the table when wagers are indicated. For purposes of this disclosure, the term “virtual” means a graphical video representation of a real object or person, such as a dealer, cards and chips, for example.

The individual player positions preferably have a separate intelligence at each player position that accepts player input and communicates directly with a game engine (main game computer or processor). The intelligence is preferably an intelligent board that can process information. For purposes of this disclosure, the term “intelligent” refers to the ability to execute code, either provided in the form of software or hardware circuits or both. Such processing may at least comprise some of signal converting (e.g., signals from player card readers, credit deposit, currency readers, coin readers, touch screen signals, control panel signals) into a signal that can be included in an information packet and interpreted by the main game computer when the signal is sent. Communication between the intelligence at each player position is direct to the main game computer and may be by self-initiated signal sending, sequenced polling by the main game computer (e.g., each position communicates directly to the main game computer in turn), timed communication, or any other order of communication that is direct between the intelligence and the main game computer.

One preferred form of communication between the main game computer and player station computers is by means of self-initiated signal sending. There is essentially a single main game computer that contains video display controls and programs for both the dealer display and the table top display, audio controls and programs, game rules (including storage of multiple games if intended to be available on the machine), random number generator, graphic images, game sequence controls, security systems, wager accounting programs, external signaling and audit functions, and the like. In other forms of the invention, the above functions are divided between a main processor and one or more additional processors. The intelligence at each player position speeds up the performance of all aspects of the game by being able to communicate directly with the main game computer and being able to process information at the player position rather than merely forwarding the information in raw form to the main game computer. Processing player information at player positions frees up resources for use by the main processor or processors.

A card game system may also include a suitable data and control processing subsystem that is largely contained within a main control module supported beneath the tabletop. The control and data processing subsystem includes a suitable power supply for converting alternating current from the power main as controlled by a main power switch. The power supply transforms the alternating line current to a suitable voltage and to a direct current supply. Power is supplied to a power distribution and sensor/activity electronics control circuit. Commercially available power switching and control circuits may be provided in the form of a circuit board that is detachable, and plugs into a board receptacle of a computer mother board or an expansion slot board receptacle. A main game controller motherboard may include a central microprocessor and related components well-known in the industry as computers using Intel brand PENTIUM® microprocessors and related memory or intelligence from any other manufacturing source. A variety of different configurations and types of memory devices can be connected to the motherboard as is well known in the art. Of particular interest is the inclusion of two flat panel display control boards connected in expansion slots of the motherboard. Display control boards are each capable of controlling the images displayed for the dealer video display and for each of the player position display areas on the continuous display screen on the table and other operational parameters of the video displays used in the gaming system. More specifically, the display control boards are connected to player bet interface circuits for the player stations. This arrangement also allows the display control boards to provide necessary image display data to the display electronic drive circuits associated with the dealing event program displays and the dealer display.

The motherboard and/or the individual player intelligent boards also include a serial port that allows stored data to be downloaded from the motherboard to a central casino computer or other additional storage device. In one example, each player board communicates directly with the casino computer system. This allows card game action data to be analyzed in various ways using added detail, or by providing integration with data from multiple tables so that cheating schemes can be identified and eliminated, and player tracking can be maintained. Player performance and/or skill can be tracked at one table or as a compilation from gaming at multiple tables, as by using BLOODHOUND™ security software marketed by Shuffle Master, Inc., which may be incorporated into this automated gaming system. Additionally, player hand analysis can be performed. The motherboard and/or individual player intelligent boards may also have a keyboard connection port that can be used to connect a larger format keyboard to the system to facilitate programming and servicing of the system.

Although the preferred system shown does not require features illustrated for receiving automated player identification information, such features can alternatively be provided. Card readers such as used with credit cards or other identification code reading devices can be added in the system to allow or require player identification in connection with play of the card game and associated recording of game action by one of the processors. Such a user identification interface, for example, a card reader located at each player station, can be implemented in the form of a variety of magnetic card readers commercially available for reading user-specific identification information. The user-specific information can be provided on specially constructed magnetic cards issued by a casino, or magnetically coded credit cards or debit cards frequently used with national credit organizations such as VISA®, MASTERCARD®, AMERICAN EXPRESS®, casino player card registry, banks and other institutions. The information could also be provided on other writable media, such as an RFID chip with writable memory, or bar coding, as just a few examples.

Alternatively, it is possible to use so-called smart cards to provide added processing or data storage functions in addition to mere identification data. For example, the user identification could include coding for available credit amounts purchased from a casino. As a further example, the identification card or other user-specific instrument may include specially coded data indicating security information such as would allow accessing or identifying stored security information that must be confirmed by the user after scanning the user identification card through a card reader. Such security information might include such things as file access numbers that allow the central processor to access a stored security clearance code that the user must indicate using input options provided on displays using touch screen displays. A still further possibility is to have participant identification using a fingerprint image, eye blood vessel image reader, or other suitable biological information to confirm identity of the user that can be built into the table. Still further, it is possible to provide such participant identification information by having the pit personnel manually code in the information in response to the player indicating his or her code name or real name. Such additional identification could also be used to confirm credit use of a smart card or transponder. All or part of the functions dedicated to a particular player station are controlled by the player station intelligence in one form of the invention. Additionally, each player station intelligence may be in communication with a casino accounting system.

It should also be understood that the continuous screen can alternatively be provided with suitable display cowlings or covers that can be used to shield display of card images from viewing by anyone other than the player in games where that is desirable. This shielding can also be effected by having light-orientation elements in the panel, and some of these light-orientation elements are electronically controllable. In this manner, the processor can allow general viewing of cards in games where that is desirable or tolerated, and then alter the screen where desired. These types of features can be provided by nanometer, micrometer or other small particulate or flake elements within a panel on the viewing area that are reoriented by signals from the processor. Alternatively, liquid crystal or photo chromatic displays can be used to create a screening effect that would allow only viewers at specific angles of view from the screen area to view the images of cards. Such an alternative construction may be desired in systems designed for card games different from blackjack, where some or all of the player or dealer cards are not presented for viewing by other participants or onlookers. Such display covers or cowlings can be in various shapes and configurations as needed to prevent viewing access. It may alternatively be acceptable to use a player-controlled switch that allows the display to be momentarily viewed and then turned off. The display can be shielded using a cover or merely by using the player's hands. Still further, it is possible to use a touch screen display that would be controlled by touch to turn on and turn off. Similar shielding can be used to prevent others from viewing the display.

A review of the figures will assist in a further understanding of the invention.

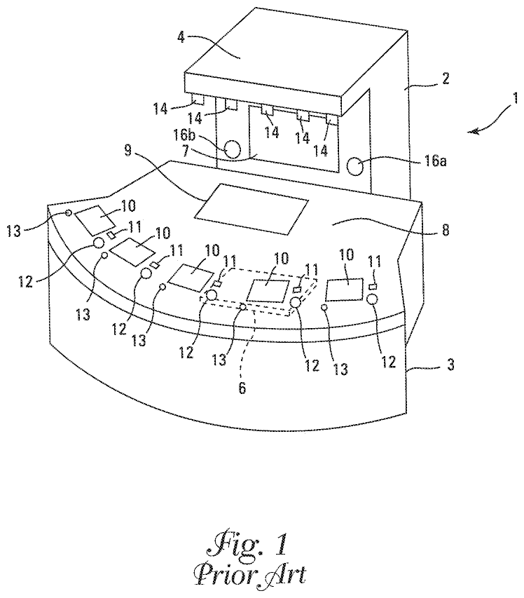

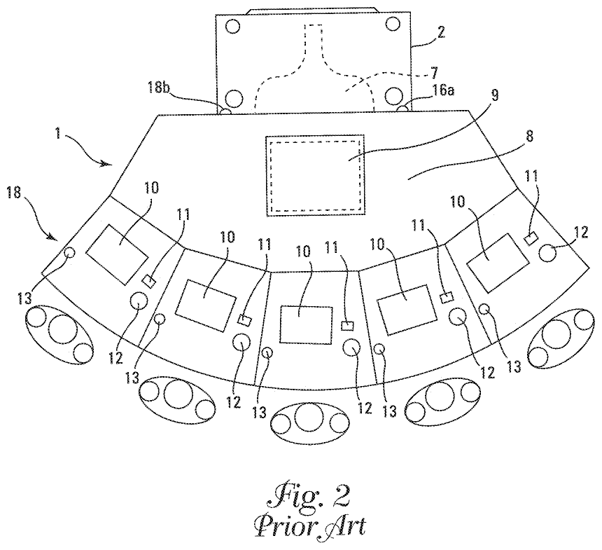

FIG. 1 shows a fully automated gaming table 1 of the prior art, as disclosed in U.S. Patent Application 2003/0199316. The system 1 comprises a vertical upright display cabinet 2 and a player bank or station cluster arrangement 3. The vertical display cabinet 2 has a viewing screen 7 on which images of the virtual dealer are displayed. The top 8 of the player bank arrangement 3 has individual monitor screens 10 for each player position, as well as tabletop inserted coin acceptors 11, and player controls 12 and 13. There is a separate and larger dealer's hand screen 9 on which dealer cards are displayed in a format large enough for all players to view. Speakers 16a and 16b are provided for sound transmission and decorative lights 14 are provided.

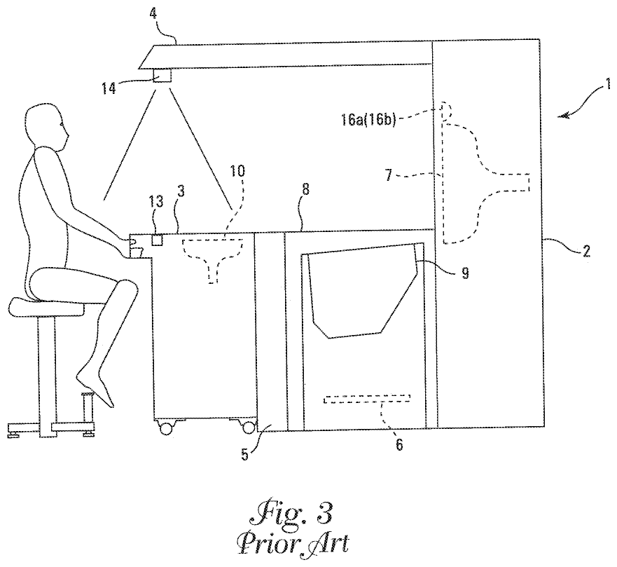

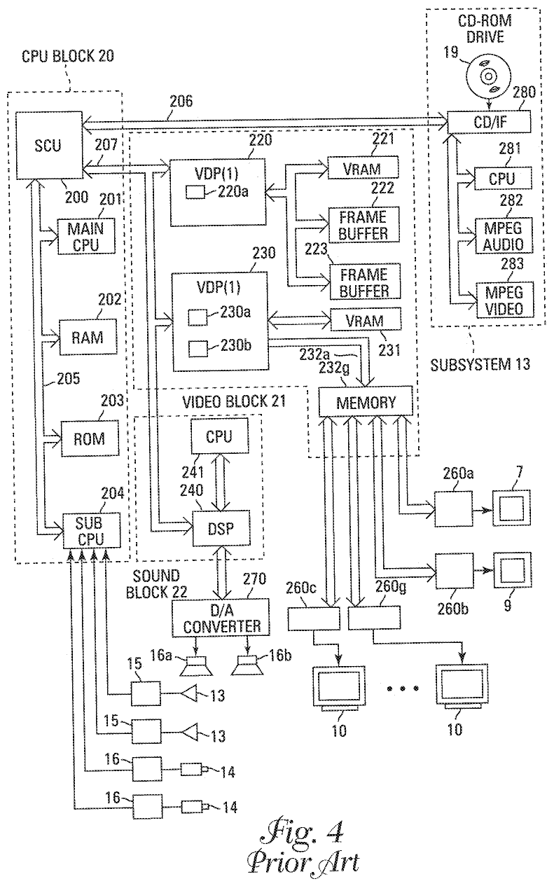

FIG. 2 shows an overhead view of the same prior art automated gaming system 1 with the viewing screen 7 shown more clearly as a CRT monitor. It can also be seen that each player position has to form an arc cut into the semicircular player seating area 18. FIG. 3 shows a side view of the same prior art automated gaming system of FIGS. 1 and 2 where the orientation of the three different types of CRT monitors 7, 9 and 10 are shown.

FIG. 4 shows the schematic circuitry of a prior art automated system as disclosed in 2003/0199316. FIG. 4 is a block diagram of processing circuitry in the game device of FIG. 1. The game device housing comprises a CPU block 20 for controlling the whole device, a picture block 21 for controlling the game screen display, a sound block for producing effect sounds and the like, and a subsystem for reading out CD-ROM.

The CPU block 20 comprises an SCU (System Control Unit) 200, a main CPU 201, RAM 202, RAM 203, a sub-CPU 204, and a CPU bus 205. The main CPU 201 contains a math function similar to a DSP (Digital Signal Processing) so that application software can be executed rapidly.

The RAM 202 is used as the work area for the main CPU 201. The RAM 203 stores the initialization program used for the initialization process. The SCU 200 controls the busses 205, 206 and 207 so that data can be exchanged smoothly among the VEPs 220 and 230, the DSP 241, and other components.

The SCU 200 contains a DMA controller, allowing data (polygon data) for character(s) in the game to be transferred to the VRAM in the picture block 21. This allows the game machine or other application software to be executed rapidly. The sub-CPU 204 is termed an SMPC (System Manager & Peripheral Control). Its functions include collecting sound recognition signals from the sound recognition circuit 15 or image recognition signals from the image recognition circuit 16 in response to requests from the main CPU 201. On the basis of sound recognition signals or image recognition signals provided by the sub-CPU 204, the main CPU 201 controls changes in the expression of the character(s) appearing on the game screen, or performs image control pertaining to game development, for example. The picture block 21 comprises a first VDP (Video Display Processor) 220 for rendering TV game polygon data characters and polygon screens overlaid on the background image, and a second VDP 230 for rendering scrolling background screens, performing image synthesis of polygon image data and scrolling image data based on priority (image priority order), performing clipping, and the like. The first VDP 220 houses a system register 220a, and is connected to the VRAM (DRAM) 221 and to two frame buffers 222 and 223. Data for rendering the polygons used to represent TV game characters and the like is sent to the first VDP 220 through the main CPU 220, and the rendering data written to the VRAM 221 is rendered in the form of 16- or 8-bit pixels to the rendering frame buffer 222 (or 223). The data in the rendered frame buffer 222 (or 223) is sent to the second VDP 230 during display mode. In this way, buffers 222 and 223 are used as frame buffers, providing a double buffer design for switching between rendering and display for each individual frame. Regarding information for controlling rendering, the first VDP 220 controls rendering and display in accordance with the instructions established in the system register 220a of the first VDP 220 by the main CPU 201 via the SCU 200.

The second VDP 230 houses a register 230a and color RAM 230b, and is connected to the VRAM 231. The second VDP 230 is connected via the bus 207 to the first VDP 220 and the SCU 200, and is connected to picture output terminals Voa through Vog through memories 232a through 232g and encoders 260a through 260g. The picture output terminals Voa through Vog are connected through cables to the display 7 and the satellite displays 10.

Scrolling screen data for the second VDP 230 is defined in the VRAM 231 and the color RAM 230b by the CPU 201 through the SCU 200. Information for controlling image display is similarly defined in the second VDP 230. Data defined in the VRAM 231 is read out in accordance with the contents established in the register 230a by the second VDP 230, and serves as image data for the scrolling screens that portray the background for the character(s). Image data for each scrolling screen and image data of texture-mapped polygon data sent from the first VDP 220 is assigned display priority (priority) in accordance with the settings in the register 230a, and the final image screen data is synthesized.

Where the display image data is in palette format, the second VDP 230 reads out the color data defined in the color RAM 230b in accordance with the values thereof, and produces the display color data. Color data is produced for each display 7 and 9 and for each satellite display 10. Where display image data is in RGB format, the display image data is used as-is as display color data. The display color data is temporarily stored in memories 232a-232f and is then output to the encoders 260a-260f. The encoders 260a-260f produce picture signals by adding synchronizing signals to the image data, which is then sent via the picture output terminals Voa through Vog to the display 7 and the satellite displays 10. In this way, the images required to conduct an interactive game are displayed on the screens of the display 7 and the satellite displays 10.

The sound block 22 comprises a DSP 240 for performing sound synthesis using PCM format or FM format, and a CPU 241 for controlling the DSP 240. Sound data generated by the DSP 240 is converted into two-channel sound signals by a D/A converter 270 and is then presented to audio output terminals Ao via interface 271. These audio output terminals Ao are connected to the input terminals of an audio amplification circuit. Thus, the sound signals presented to the audio output terminals Ao are input to the audio amplification circuit (not shown). Sound signals amplified by the audio amplification circuit drive the speakers 16a and 16b. The subsystem 23 comprises a CD-ROM drive 19b, a CD-I/F 280, and CPU 281, an MPEG-AUDIO section 282, and an MPEG-PICTURE section 283. The subsystem 23 has the function of reading application software provided in the form of a CD-ROM and reproducing the animation. The CD-ROM drive 19b reads out data from CD-ROM. The CPU 281 controls the CD-ROM drive 19b and performs error correction on the data read out by it. Data read from the CD-ROM is sent via the CD-I/F 280, bus 206, and SCU 200 to the main CPU 201 that uses it as the application software. The MPEG-AUDIO section 282 and the MPEG-PICTURE section 283 are used to expand data that has been compressed in MPEG (Motion Picture Expert Group) format. By using the MPEG-AUDIO section 282 and the MPEG-PICTURE section 283 to expand data that has been compressed in MPEG format, it is possible to reproduce motion picture. It should be noted herein that there are distinct processors for the CPU block, video block, sound block, CD-ROM drive and memory with their independent PCUs. This requires significant computing power and still has dumb (no intelligence) player input components.

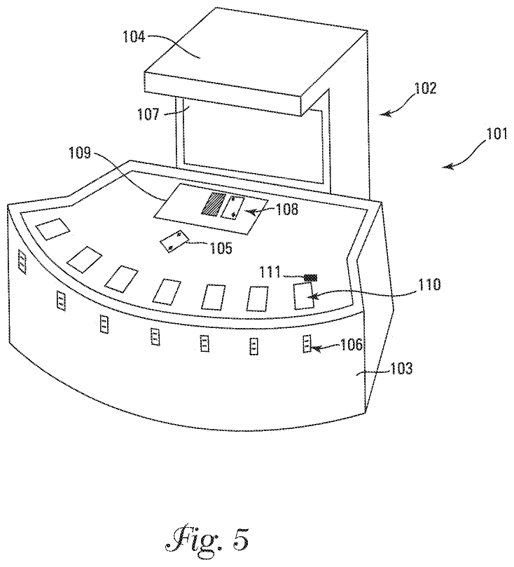

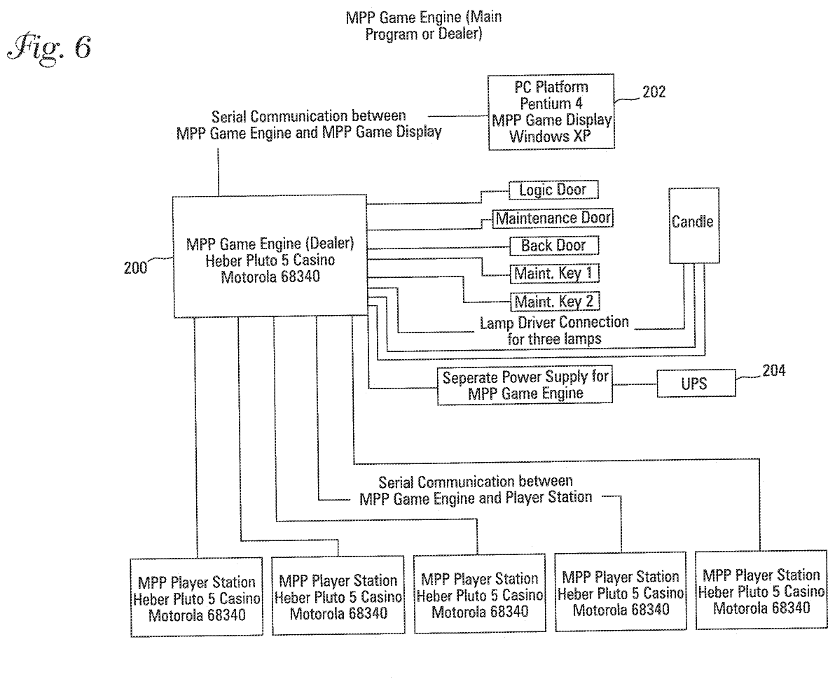

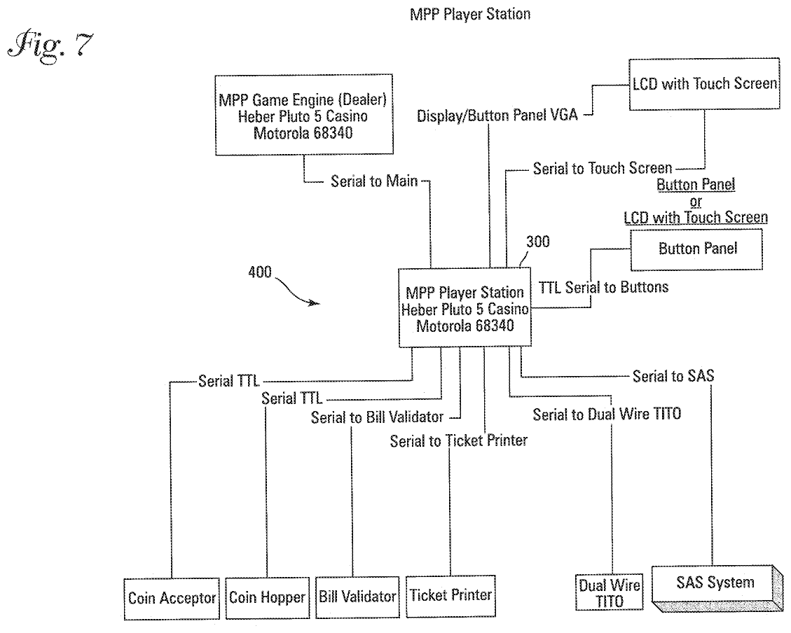

FIG. 5 shows an example of an automated table system 101 useful to practice the game play methods of the present invention. The system 101 has an upright dealer display cabinet 102 with a top 104 and the dealer viewing screen 107, which may be any form of display screen such as a CRT, plasma screen, liquid crystal screen, LED screen or the like. The player bank arrangement 103 has a continuous display screen 109 on which images of cards being dealt 105, dealer's cards 108, bets wagered 111 and touch screen player input functions 110 are displayed. Other player input functions may be provided on a panel 106, which might accept currency, coins, tokens, identification cards, player tracking cards, ticket in/ticket out acceptance, and the like.

FIG. 6 shows an electronic/processor schematic for a MultiPlayer Platform (MPP) gaming system according to the presently described invention. The MPP game engine (dealer) comprises a Heber Pluto 5 casino game board 200 (Motorola 68340 board) operating off the PC Platform PENTIUM® 4 MPP game display processor 202. The game display processor operates on a WINDOWS® XP platform. The respective subcomponents on the PENTIUM® 4 processor are labeled to show the apportionment of activity on the motherboard and the component parts added to the board. As is shown, the game engine has an uninterruptible power supply 204. The game display processor directs activity on the speakers, directs activities onto the MPP game service panel, and the plasma monitor card display. It is important to note that all communications are direct from the game display processor, freeing up resources available to the game engine processor.

FIG. 7 shows the electronic/processing schematics of the MPP player station intelligence board (Heber Pluto 5 Casino, Motorola 68340), each of which player stations (one for each player position) is in direct connection to the MPP game engine (dealer), which is, in turn, directly connected to the PC platform (not shown in FIG. 7). Each intelligence board receives information for all player input systems specific to that player station, such as the shown coin acceptor, coin hopper, bill validator, ticket printer, touch screen and/or display button panel, dual wire ticket-in/ticket-out printing and SAS system (SAS is one exemplary standard communications protocol used by a number of casinos' central computer systems.) A significant benefit resides in the use of the independent intelligence boards at each player position being in direct communication with the MPP game engine 300, as opposed to each individual player position button panel being dead or inactive until authorized by the main game processor, as previous automated gaming systems were constructed.

The above-described architecture is also an improvement in providing a system with not only the intelligence at each player position, but also in redistributing processing capability for functions among various processing components within the gaming system. In one architectural format, all functions of the gaming engine, except for the player localized intelligence functions, are consolidated into a single PC (e.g., the PENTIUM® 4 shown in the figures). This would include all game functions, player video functions, dealer video functions, dealer audio functions, security, central reporting (to a casino's central computer, for example), currency and debit functions, alarm functions, lighting functions, and all other peripherals on the system, except for the localized player functions. Alternatively, all functions requiring communication with the casino's main computer system are located on the player station intelligent boards. In this system, the main game processor would talk directly with the player intelligent boards, preferably in the same novel communication format described below.

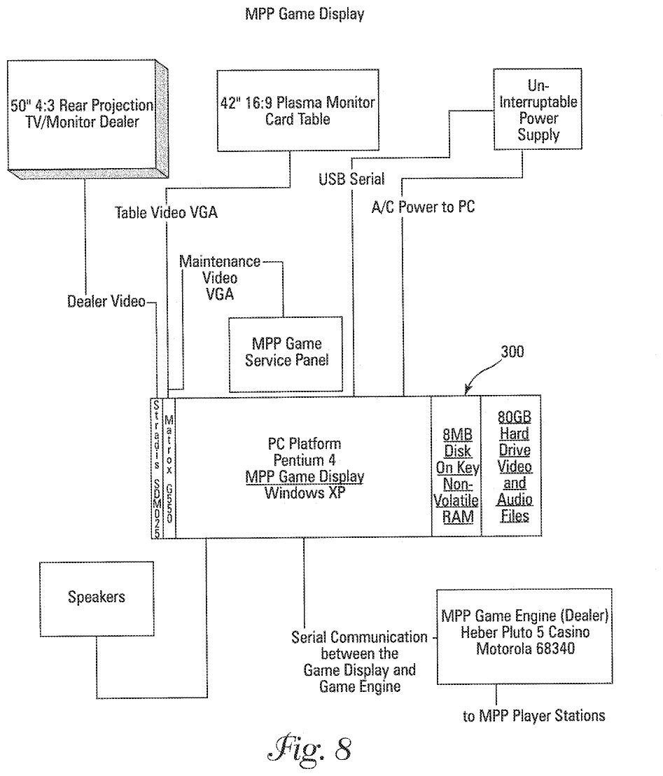

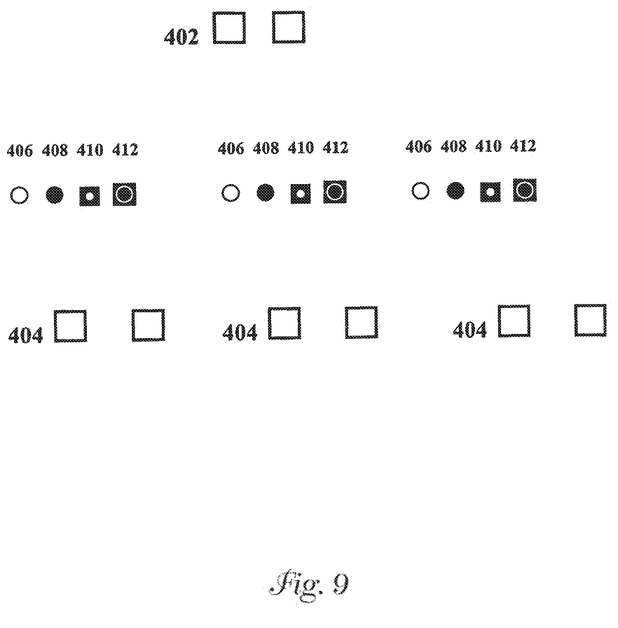

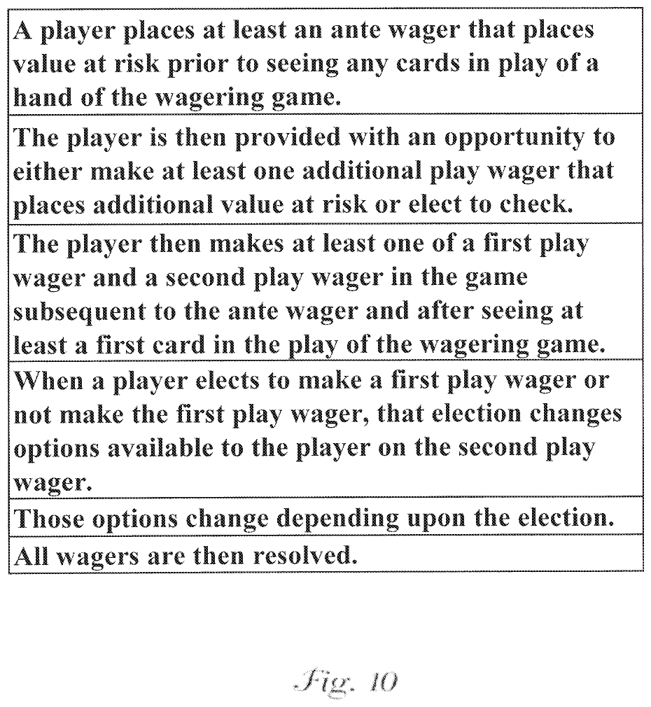

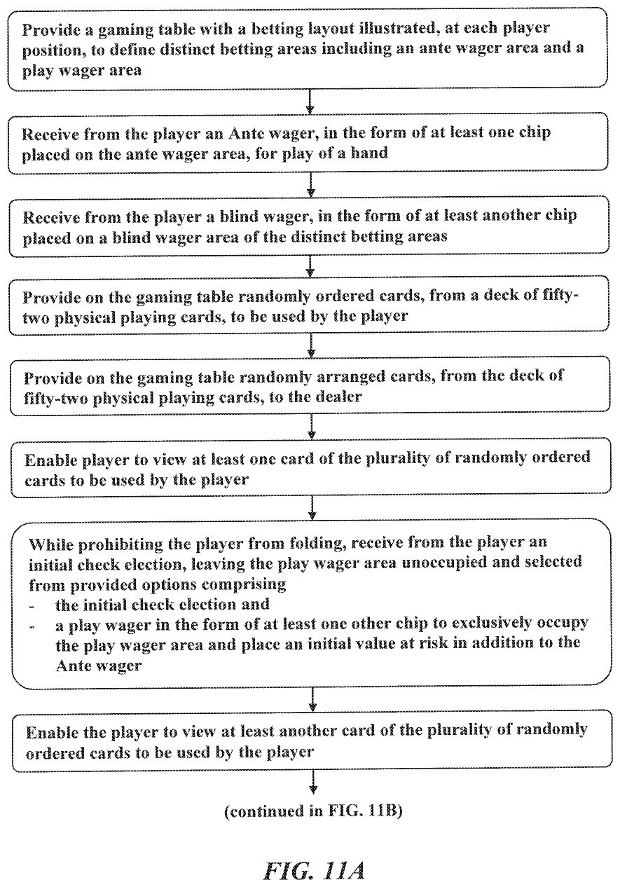

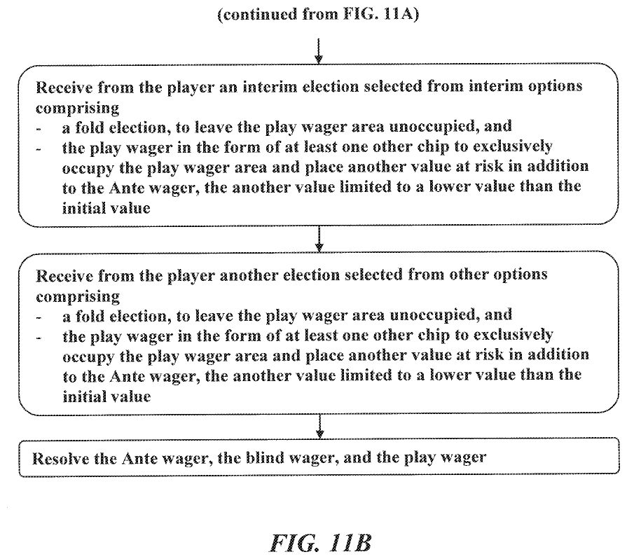

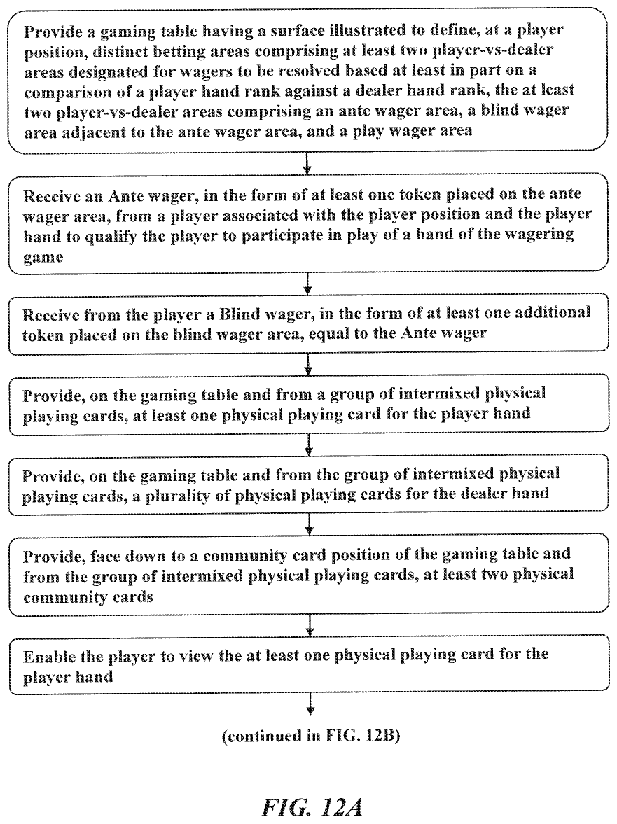

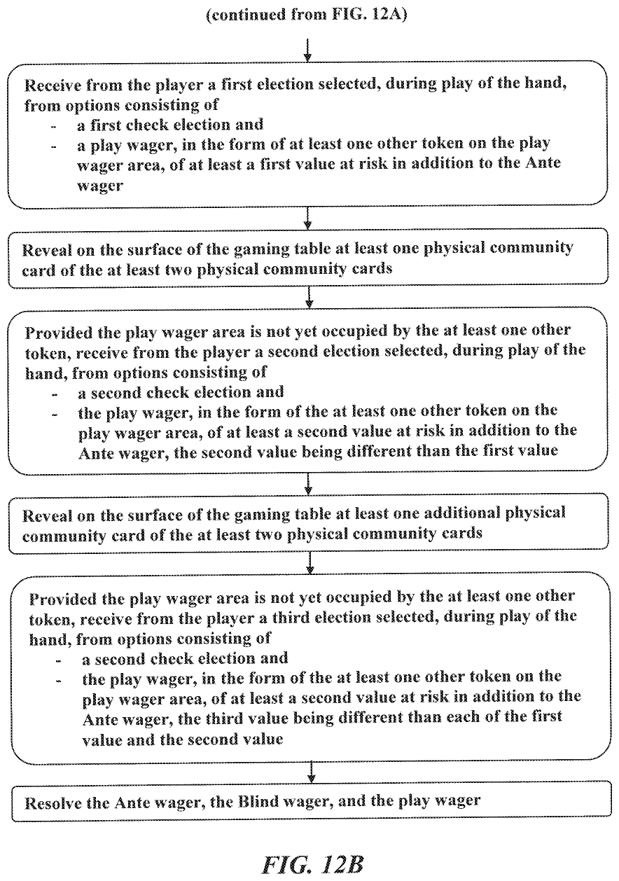

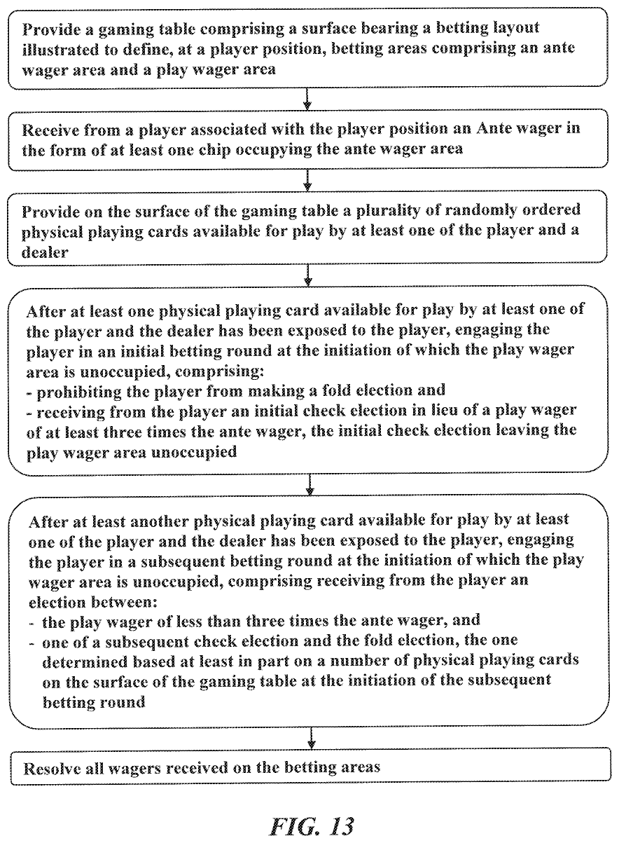

An alternative system is shown in FIGS. 6, 7 and 8, where there is a dealer engine processor intermediate the main game PC and the player intelligent boards. Both systems are a distinct improvement over the prior art, but with the higher power available for PCs and with the ease of programming a PC as opposed to an embedded system, the consolidation of the game functions and the ability of the main game engine to communicate with each of the player positions is enabled. As shown in FIG. 8, the game display processor 300 is preferably a PENTIUM® 4 PC and is separate from the main processor. With the player intelligent boards, the main game PC can receive packets of information from each player station as events occur rather than having to poll each player position on a regular basis 100 times to gain the specific information for each player input that may be made.

A description of the Heber Board (an exemplary board that can be used as a player station processor and/or game engine processor 16) a commercially available intelligent processing board is as follows. The Heber Board is known for its reliability and flexibility, especially for the Pluto 5 family of gaming products. The Pluto 5 is the controller of choice for the global gaming industry. Flexibility comes from a set of features built into the Pluto 5 (Casino) controller and from the choice of optional add-on boards that can be used to adapt the Pluto family to best suit individual applications. In the area of interfacing, there are three distinct boards, each of which serves a particular function in helping the Pluto 5 to connect with the world outside:

### RS485 Board

RS485 is an industrial-grade board for linking multiple systems in unforgiving circumstances for centralized information gathering. The Heber RS485 board is fully opto-isolated to provide complete circuit safety when used within “electrically noisy” environments. The RS485 board uses a single RS232 connection to the Pluto 5 board and all necessary power is also derived through this link. Two header connectors may be provided for the RS485 channel to allow daisy chain connections between multiple systems.

### HII/ccTalk Board

This board specializes in communicating with industry standard note/coin acceptors and payout hoppers. Equipped with dual communication channels, each port is configurable to use either the HII format to connect with MARS® coin/note acceptors or the ccTalk format for MONEY CONTROL® hoppers. Both channels are controlled via a single RS232 connection to the Pluto 5 board and all necessary power is also derived through this link. The HeberFASTTRACK™ package contains modular library functions for passing information via these channels.

### Four-Channel Relay Board

The relay board allows control of medium- to high-level loads such as solenoids, without risk of damage or interference to the Pluto 5 circuitry. Four power-switching channels are available with absolute isolation from the Pluto 5 control signals. Each relay is capable of switching direct or alternating currents of up to 7 A at a maximum voltage of 250V.

Like the Pluto 5 board itself, its modular options have been used extensively so that their designs are fully developed and entirely stable. The options that are specified are consistently provided in mass quantities. As with all Pluto products, programming for the modular options is straightforward. This is enhanced with the use of the Pluto 5 Enhanced Development Kit and also the FASTTRACK™ package. Between them, these kits contain all of the low-level and high-level programming tools and library functions needed for gaming applications. These systems can be provided through a Pluto 5 Enhanced Development Kit datasheet 80-15353-7 (Heber Limited, Belvedere Mill, Chalford, Stroud, Gloucestershire, GL6 8NT, UK Tel: +44 (0) 1453 886000 Fax: +44 (0) 1453 885013, on the world-wide web at heber.co.uk. Specifications for the various boards are identified below.

### RS485 Interface

Host interface

RS232 connection to Pluto 5/Pluto 5 Casino

All power provided via RS232 link from host system Communication port

Dual four-way Molex 0.1″ KK headers for daisy chaining purposes Dimensions

80×61 mm (3.14×2.4″)
Part number

Opto-isolated RS485 board 01-14536-2
HII/ccTalk interface
Host interface

RS232 connection to Pluto 5/Pluto 5 Casino

All power provided via RS232 link from host system
Communication port

Single or dual ten-way header connectors
Dimensions

101.6×69.85 mm (4×2.8″)
Part number

Dual channel HII/ccTalk board 01-16171-2

### Four-Channel Relay Board

Host interface

Connection to Pluto 5/Pluto 5 Casino via ribbon cable using four standard output lines

All power provided via ribbon cable link from host system
Switching capabilities

Up to 250V AC or DC @7A maximum per channel
Dimensions

80×61 mm (3.14×2.4″)
Part number

Four channel relay board
01-15275-1
80-16949-1

One proposed hardware configuration uses a “satellite” intelligent processor at each player position. The player station satellite processor is substantially the same as the primary game engine processor, a Heber Pluto 5 Casino board. The satellite processors receive instruction from the primary game engine but then handle the communications with player station peripherals independently. Each satellite processor communicates with only the peripherals at the same player station. Thus, each player station has a dedicated satellite processor communicating with only the peripherals at the same player station and with the casino's central computer system. The peripherals are, but not limited to: slot accounting systems, bill validator, ticket printer, coin acceptor, coin hopper, meters, button panel or LCD touch screen and various doors and keys.

The satellite processors run proprietary software to enable functionality. The player station software is comprised of two modules, the first being an OS similar to the game engine operating system and the second being station software that handles peripheral communications. The software may be installed on EPROMs for each satellite processor. The primary method of communication between the satellite processors and the primary game engine is via serial connectivity and the previously described protocol. In one example, information packets are prepared by the satellite processors and are sent to the game engine processor on the happening of an event.

The proposed game engine provides communication to the player stations to set the game state, activate buttons and receive button and meter information for each player station. Communication is via a serial connection to each of the stations. The new protocol for communication between the game engine, game display and player stations is an event driven packet-for-packet bi-directional protocol with Cyclic Redundancy Check (CRC) verification. This is distinguished from the Sega system that used continuous polling. This communication method frees up resources in the same engine processor because the processor no longer needs to poll the satellites continuously or periodically.

The new protocol uses embedded acknowledgement and sequence checking. The packet-for-packet protocol uses a command packet, response packet and a synchronization packet as illustrated below. The protocol uses standard ASCII characters to send data and a proprietary verification method.

Format of Command Packet

| STX | SEQ | DATA LENGTH | DATA | CRC-16 | ETX |
|---|---|---|---|---|---|
| 1 | 1 | 3 | 3-999 | 5 | 1 |

Format of Response Packet

| STX | SEQ | DSP | PRV | ETX |
|---|---|---|---|---|
| 1 | 1 | 1 | 1 | 1 |

Format of Synchronization Response Packet

| STX | MTS | MRS | ETX |
|---|---|---|---|
| 1 | 1 | 1 | 1 |

Legend for Figures

| | |
|---|---|
| STX | Start of Packet Character |
| SEQ | Sequence # (Cycles from “0” through “9”) |
| LEN | Length of Data Area (“003” through “999”) |
| DATA | ASCII Data Fields Separated with “\|” Character |
| CRC | CRC-16 Value (“0000” through “65535”) Cyclic Redundancy |
| | Check |
| ETX | End of Packet Character |
| DSP | Disposition Code (“A” ACK, “N” NAK, or “I” Invalid |
| | Sequence) |
| PRV | Sequence Number of Last ACK'ed Packet (0 thru 9) |
| MTS | Main's Current Transmit Sequence Number |
| MRS | Main's Current Receive Sequence Number |

The Command Packet and Response Packet are used during primary game communications. The protocol uses redundant acknowledgement. For example, the packet is initially acknowledged when first received by the recipient. The same recipient will resend another acknowledgement in the next communication. This second acknowledgement is the “PRV” data in the response packet.

The communications between the game engine and the player station intelligence is preferably a transaction-based protocol. Either device can start a transaction, which is why it is essential that there be an intelligent board at each player position. All packets of information may be sent in any acceptable format, with ASCII format preferred as a matter of designer choice. All command packets usually contain a sequence number that is incremented after each successful packet exchange. The game engine and the player station intelligence use sequence numbers that are independent of each other. The sequence number keeps the communications in synchronization. This synchronization method is described later.

The command packet is used to send various commands such as inputs, lamps, doors, errors, chirp, game results, player input, coin acceptance, player identification, credit acceptance, wagers, etc. The command packet format may be, by way of a non-limiting example:
<STX><Sequence number><Data Length><Data><CRC-16><ETX>

The data format within the command packet may be:
<Address><Command><Field 1>|<Field 2>|<Field n>|

The response packet format may be:
<STX><Sequence number><Disposition><Previous ACK><ETX>\

The sync request packet format may be:
<SYN>

The sync response packet format may be:
<STX><Mains Current Transmission Sequence><Mains Current Receive Sequence><ETX>

A major strength of the protocol is its resilience of the game protocol and its ability to free up resources within the game engine. Those resources can, in turn, be used to provide more intricate games and multi-media affects.

### Synchronization Method:

The satellite and host must become synchronized in order to provide for reliable communications using packet numbers. To facilitate this, a novel protocol synchronization method is used. Upon applying power to the satellite, or after a communications failure, the satellite automatically enters into synchronization mode. In the synchronization mode, the satellite sends out the ASCII SYN (0x16) character about every second. It is expecting a special response packet containing transmit and receive packet sequence numbers to be used from that point on. After receiving the special response packet, the sequence numbers are used as-is, and not incremented until a successful packet exchange is completed. After communications are synchronized, the sequence numbers are incremented after each packet is successfully sent or received.

As was noted before, the main game processor may contain information, data, programming and other necessary functions to enable the play of multiple games off the same machine. For example, the main game engine may have rules and commands that will enable play of high and low games of the present invention and other card games. The system may be controlled so that different games may be played at different times on command of the casino or players.

What is claimed is:

1. A method of administering a wagering game, comprising:
accepting an ante wager from a player by receiving a chip on a surface of a table;
dealing a partial hand to the player from a set of randomly ordered cards and permitting the player to view the partial hand;
after permitting the player to view the at least one card and while prohibiting the player from folding, accepting from the player an initial election to check after offering the player initial options selected from the group consisting of check or place a play wager of a first value;
dealing at least one other card from the set available to the player to form a complete hand and permitting the player to view the at least one other card;
after permitting the player to view the at least one other card, accepting from the player a subsequent election to place a play wager of a second, lesser value by receiving another chip on the surface of the table after offering the player subsequent options selected from the group consisting of fold or place the play wager of the second value or less; and
resolving the ante wager and the play wager.

2. The method of claim 1, wherein the dealing the partial hand comprises dealing two cards to the player.

3. The method of claim 1, dealing the at least one other card comprises dealing the at least one other card to a community card position.

4. The method of claim 3, wherein dealing the at least one other card to the community card position comprises dealing five other cards to the community card position.

5. The method of claim 1, wherein offering the player the initial options selected from the group consisting of check or place the play wager of the first value comprises offering the player the initial options selected from the group consisting of check or place the play wager of three times to four times the ante wager.

6. The method of claim 1, wherein offering the player the subsequent options selected from the group consisting of fold or place the play wager of the second value or less comprises offering the player the subsequent options selected from the group consisting of fold or place the play wager of up to two times the ante wager.

7. The method of claim 1, further comprising:
after accepting from the player the initial election and before accepting from the player the subsequent election, accepting from the player an interim election to check while prohibiting the player from folding after offering the player interim options selected from the group consisting of check or place the play wager of a third, intermediate value between the first value and the second value or less.

8. The method of claim 1, further comprising dealing another partial hand to be used by a dealer from the set.

9. The method of claim 8, wherein dealing the other partial hand comprises dealing two other cards to the dealer.

10. The method of claim 9, wherein permitting the player to view the at least one other card comprises permitting the player to view three community cards before accepting from the player the subsequent election to place the play wager of the second, lesser value.

11. The method of claim 8, wherein resolving the at least the ante wager and the play wager comprises comparing a best five-card poker hand from the cards available to the player to a best five-card poker hand from the cards available to the dealer.

12. The method of claim 11, further comprising returning possession of at least the ante wager to the player when the best five-card poker hand from the cards available to the dealer does not meet or exceed a pair.

13. The method of claim 11, further comprising accepting a blind wager from the player before dealing the partial hand to the player and before accepting the ante wager, wherein accepting the ante wager occurs after permitting the player to view the partial hand.

14. The method of claim 13, further comprising returning possession of the blind wager to the player when the best five-card poker hand from the cards available to the player outranks the best five-card poker hand from the cards available to the dealer and is of a predetermined winning hand rank or higher.

15. A system for automatically administering a wagering game, comprising:
a display configured to display real-time game information, an operator interface, a nontransitory memory, and at least one processor operatively connected to the display, the operator interface, and the nontransitory memory, the at least one processor programmed to:
accept an ante wager from a player;
randomly generate a partial hand from a set of cards and cause the display to display the partial hand;
after displaying the partial hand the player while prohibiting the player from folding, accept from the player an initial election to check via the operator interface after displaying initial options selected from the group consisting of check or place a play wager of a first value;
cause the display to display at least one other card randomly selected from the set available to the player to form a complete hand;
after displaying the at least one other card, accept from the player a subsequent election to place a play wager of a second, lesser value after displaying subsequent options selected from the group consisting of fold or place the play wager of the second value or less; and
resolve the ante wager and the play wager.

16. The system of claim 15, wherein the at least one processor is programmed to randomly generate the partial hand comprising two cards and cause the display to display the two cards of the partial hand.

17. The method of claim 15, wherein the at least one processor is programmed to cause the display to display five other cards randomly selected from the set available as community cards to the player to form a complete hand.

18. The method of claim 15, wherein the at least one processor is programmed to randomly generate another partial hand to be used by a dealer from the set and cause the display to display the other partial hand face down.

19. The method of claim 18, wherein the at least one processor is programmed to resolve the at least the ante wager and the play wager by comparing a best five-card poker hand from the cards available to the player to a best five-card poker hand from the cards available to the dealer.

20. The method of claim 19, wherein the at least one processor is programmed to accept a blind wager from the player before causing the display to display the partial hand and before accepting the ante wager, wherein accepting the ante wager occurs after causing the display to display the partial hand.
